(19) United States
(12) Patent Application Publication
(10) Pub. No.: US 2022/0098106 A1
(43) Pub. Date: Mar. 31, 2022

(54) STORAGE STABLE CEMENT PASTES

(71) Applicant: Dow Global Technologies LLC, Midland, MI (US)

(72) Inventors: Debora Ressnig, Zuerich (CH); Margarita Perello, Horgen (CH)

(21) Appl. No.: 17/424,619

(22) PCT Filed: Mar. 31, 2020
(86) PCT No.: PCT/US2020/025876

§ 371 Date: Jul. 21, 2021

Related U.S. Application Data
(60) Provisional application No. 62/834,457, filed on Apr. 16, 2019.

(51) Int. Cl. C04B 28/06; C04B 40/00

(52) U.S. Cl. CPC C04B 28/06; C04B 2103/009; C04B 40/0039

(57) ABSTRACT

The present invention relates to substantially water free hydraulic cement pastes which remain shelf stable over extended time periods, for example, 100 days at room temperature. The substantially water free cement pastes comprise a deep eutectic solvent mixture of a polar organic carrier component, such as a hydrogen donor like a polyol, in association with an anhydrous cation containing component, and a hydraulic cement, preferably, an aluminate cement, or sulpho-aluminate cement. A preferred deep eutectic solvent mixture comprises K₂CO₃ and glycerol in molar ratios of from 1:1 to 1:6. The cement pastes are activated simply by addition of water or aqueous polymers to form thin set compositions.

The present invention relates to hydraulic cement pastes which remain shelf stable over extended time periods, for example, 30 days or more at room temperature. In particular, the present invention relates to hydraulic cement compositions wherein the cement is dispersed in a substantially water free deep eutectic solvent mixture as a carrier, preferably, of a polar organic carrier component, such as a hydrogen bond or electron donor, and an anhydrous cation containing component, such as choline chloride or a salt. The resulting cement paste can be activated on demand by combining it with water.

Hydraulic cement in a liquid form combines the advantages of being pumpable, enabling low dust production, having ready miscibility with other components in two component (2K) approaches and providing freedom of formulation with other additives, such as gloss modifiers, cure agents, and hydrophobicity imparting agents. However, there are few available hydraulic cement pastes because such cements react readily with water and harden in a few hours. Methods to stabilize cement in water using strong, covalently binding acids as blocking agents have been known since the 1980's. In contrast, the dispersion of hydraulic cements in commonly available organic solvents has proven difficult because of, among other things, the high density of the cement and the safety and toxicity issues presented by organic solvents.

Cement pastes containing dry hydraulic cement that is mixed with water right before the application are well-known two-component (2K) compositions in construction. Such pastes have a short shelf life prior to cure and so must be used directly upon mixing the components together. Accordingly, the pastes have to be applied or poured right after mixing and before they set.

Calcium aluminate cements (CAC) stabilized in water have been disclosed. US20140343194 to Taquet et al. provides (sulpho)aluminous cements, for example, CAC stabilized with phosphoric acid instead of boric acids or acetic acid derivatives. CACs, for example, are highly reactive and provide early strength and fast cure. They have been used to accelerate the setting of cements, concretes and, more recently, to accelerate the setting of organic coatings at a high humidity and/or low temperature. However, the compositions of Taquet depend on use of acids and an acidic pH preparation and so need a caustic or basic substance for their activation; they cannot be activated solely with water. Further, the compositions of Taquet are made in a series of mixing steps wherein the acid has to be dispersed first, followed by forming a suspension of the cement materials at an acid pH.

1. In accordance with the present invention, the present inventors have solved the problem of providing a shelf stable liquid cement or paste that can be made by simple mixing of ingredients in any order and which can be made reactive merely by addition of water or moisture.

STATEMENT OF THE INVENTION

1. In accordance with the present invention, a substantially water free cement paste composition that is activated by water comprises a deep eutectic solvent mixture of a polar organic carrier component, preferably, one or more polar protic organic liquids, in association with an anhydrous cation containing component, and, further, comprises a hydraulic cement, wherein the deep eutectic solvent is a liquid or fluid at 10° C. or less, or, preferably, 0° C. or less, or, more preferably, −15° C. or less. Preferably, the substantially water free cement paste composition of the present invention remains shelf stable over extended time periods, for example, 6 days or more at room temperature, or, more preferably, 30 days or more at room temperature.

2. In accordance with the substantially water free cement paste composition present invention as in item 1, above, wherein the polar organic carrier component of the deep eutectic solvent mixture is chosen from a hydrogen donor.

3. In accordance with the substantially water free cement paste composition of the present invention as in any one of items 1 or 2, wherein the polar organic carrier component of the deep eutectic solvent mixture is chosen from glycerol, ethylene glycol, C₃ to C₁₈ alkane diols, urea, acetamide, 1-methyl urea, 1,3-dimethyl urea, thiourea, benzamide, carboxylic acids, such as weak carboxylic acids, polyols or carbohydrates, oligomers or polymers of a diol, oligomers or polymers of a polyol, such as polyalkoxylated polyols, oligomers or polymers of an organic acid, oligomers or polymers of a carbohydrate, oligourethanes, polypeptides, or two or more of these.

4. In accordance with the substantially water free cement paste composition of the present invention as in any one of items 1, 2, or 3, above, wherein the polar organic carrier component is chosen from glycerol, polyalkoxylated glycerol, anhydrous ethylene glycol, urea, acetamide, 1-methyl urea, 1,3-dimethyl urea, thiourea, saccharides, oligomers or polymers of a saccharide, oligomers or polymers of a polyol, oligomers or polymers of an organic acid, oligourethanes, or two or more of these, wherein, preferably, any oligourethane, oligomer or polymer of a polyol, oligomer or polymer of an organic acid or oligomer or polymer of a saccharide has a formula molecular weight (formula weight) of from 150 to 2,000, or, more preferably, a formula weight of from 150 to 1,000 or two or more of these.

5. In accordance with the substantially water free cement paste composition of the present invention as in any one of items 1, 2, 3 or 4, above, wherein the amount of the polar organic carrier component in the deep eutectic solvent mixture ranges from 40 to 99 mol. %, or, preferably, from 50 to 95 mol. %, or, more preferably, from 60 to 90 mol. % with the remainder comprising the anhydrous cation containing component.

6. In accordance with the substantially water free cement paste composition of the present invention as in any one of items 1, 2, 3, 4 or 5, above, wherein the anhydrous cation containing component is chosen from non-toxic quaternary ammonium containing materials; ammonium salts, organoammonium salts, simple salts, for example, of metals; salts of cyanamide; metal cations combined with non-volatile amines; onium salts; metal cations combined with organic nitrides; metal cations combined with organic sulfonates, metal cations combined with organic sulphonyl group containing compounds, or two or more of these.

7. In accordance with the substantially water free cement paste composition of the present invention as in any one of items 1, 2, 3, 4, 5, or 6, above, wherein the anhydrous cation containing component is chosen from choline chloride (ChCI), (hydroxyethyl) trimethylammonium chloride, ammonium chloride, 1-n-butyl-3-methylimidazolium salts, metal carbonates, semi-metal carbonates, metal halides, semi-metal halides, metal nitrates, metal nitrites, metal sulphates, metal phosphates, salts of cyanamide, metal citrates, metal acetates, metal cations combined with non-volatile amines, benzyltriphenylphosphonium halides, (CF₃CO₂)₂N, metal cations combined with trifluoromethanesulfonate, metal cations combined with bis(trifluoromethanesulphonyl) imide, and metal cations combined with tris(trifluoromethanesulphonyl) methide, or two or more of any of these, preferably, choline chloride or metal carbonates.

8. In accordance with the substantially water free cement paste composition of the present invention as in item 1, above, wherein the deep eutectic solvent mixture comprises K₂CO₃ and glycerol in molar ratios of from 1:1 to 1:6, K₂CO₃ and ethylene glycol, preferably, anhydrous ethylene glycol, in molar ratios of from 1:3 to 1:8 or K₂CO₃ and propoxylated glycerol in molar ratios of from 1:14 to 1:30, or, preferably, from 1:16 to 1:24.

9. In accordance with the substantially water free cement paste composition of the present invention as in any one of items 1, 2, 3, 4, 5, 6, 7, or 8, above, wherein the hydraulic cement is chosen from Ordinary Portland cement, aluminate cement, sulpho-aluminate cement, gypsum and their mixtures, preferably, a cement chosen from Ordinary Portland cement, aluminate cement, and their mixture, or, more preferably, alkali aluminate cement.

10. In accordance with the substantially water free cement paste composition of the present invention as in any one of items 1, 2, 3, 4, 5, 6, 7, 8, or 9, above, wherein the composition comprises anhydrous additives chosen from pigments, inorganic colloidal particles or fillers (e.g. alumina or silica), reducing agents, synthetic thickeners, dispersants, polycarboxylates, polymeric superplasticizers, plasticizers, oils, defoamers, air entraining agents, or two or more of any of these, preferably, superplasticizers.

11. In accordance with the substantially water free cement paste compositions as set forth in any one of items 1, 2, 3, 4, 5, 6, 7, 8, 9 or 10, wherein the amounts of the deep eutectic solvent mixture range from 20 to 80 wt. %, or, preferably, from 25 to 65 wt. %, based on the total weight of the composition.

12. In accordance with the substantially water free cement paste compositions as set forth in any one of items 1, 2, 3, 4, 5, 6, 7, 8, 9, 10, or 11, above, wherein the amounts of the hydraulic cement solids range from 20 to 73 wt. % or, preferably, from 40 to 70 wt. %, based on the total weight of the composition.

13. In accordance with the substantially water free cement paste compositions as set forth in any one of items 1, 2, 3, 4, 5 ,6 ,7, 8, 9, 10, 11, or 12, above, wherein the total amount of the anhydrous additives, with the exception of fillers, ranges from 0 to 40 wt. %, or, preferably, from 0 to 30 wt. %, based on the total weight of the cement paste composition, and wherein the total amount of substantially anhydrous fillers ranges up to 60 wt. %, or, preferably, from 10 to 40 wt. %, of the total cement paste composition.

14. In accordance with another aspect of the present invention, a method of making a substantially water free cement paste composition comprises mixing together a polar organic carrier component and one or more anhydrous cation containing component for a period of from 10 min to 48 hours or, preferably, from 1 to 24 hours and at temperatures of from room temperature to the boiling point of the polar organic carrier component, for example, 150° C., or, preferably, from 40 to 100° C. to form a deep eutectic solvent mixture, followed by dispersing in either order of addition, a hydraulic cement and one or more anhydrous additives, if used, in the deep eutectic solvent mixture.

15. In accordance with the method of making a substantially water free cement paste composition as in item 14, above, wherein the mixing together of the polar organic carrier component and the anhydrous cation containing component comprises mixing in a mechanical mixer, homogenizer or a dissolver.

16. In accordance with the method of making a substantially water free cement paste composition as in any one of items 14 and 15, above, wherein the dispersing of the hydraulic cement and any anhydrous additives in the deep eutectic solvent mixture comprises dispersing in an extruder, or a mixer, such as a cement mixer, planetary mixer, Hobart mixer, or banbury mixer.

17. In accordance with yet another aspect of the present invention, a method of using a substantially water free cement paste composition as set forth in any one of items 1, 2, 3, 4, 5, 6, 7, 8, 9, 10, 11, 12, or 13, above, comprises bringing the substantially water free cement paste composition in contact with water or an aqueous liquid, such as an emulsion polymer or aqueous coating composition, and, if desired, one or more in use additive, for example, in a cement mixer, to form a hydraulic setting composition, applying or pouring the resulting hydraulic setting composition, and allowing it to cure.

18. In accordance with the method of using a substantially water free cement paste composition as in item 17, above, comprising mixing an aqueous coating composition, preferably, an aqueous emulsion copolymer composition, with the cement paste composition to form a hydraulic setting composition, and applying the hydraulic setting composition to form a thin set layer or coating, for example, by troweling on the composition or using a scree to bring the cement paste composition into contact with water or aqueous liquid form of the coating.

Unless otherwise indicated, conditions of temperature and pressure are ambient temperature and standard pressure. All ranges recited are inclusive and combinable.

Unless otherwise indicated, any term containing parentheses refers, alternatively, to the whole term as if no parentheses were present and the term without them, as well as combinations of each alternative. Thus, the term “(poly)diol” refers to any of a diol, a polydiol or their mixtures. All ranges are inclusive and combinable. For example, the term “a range of from 20 to 80 wt. %, or, preferably, from 25 to 65 wt. %” of a deep eutectic solvent mixture would include each of from 20 to 25 wt. %, from 20 to 80 wt. %, from 20 to 65 wt. %, from 25 to 80 wt. %, from 65 to 80 wt. %, and, preferably, from 25 to 65 wt. % of a deep eutectic solvent mixture.

As used herein, the term “anhydrous” is used interchangeably with “substantially water free” and means that a composition may comprise some substantially water free salts that contain water of hydration; thus, and “anhydrous additive” can include a salt that contains some water of hydration so long as the total cement paste composition remains substantially water free. As used herein, the term “ASTM” refers to publications of ASTM International, West Conshohocken, Pa.

As used herein, the term “deep eutectic solvent mixture” means a mixture of two or more materials that are capable of self-association, such as through hydrogen bond interactions, to form a eutectic mixture with a melting point lower than that of each individual component.

As used herein, the term “freezing point” refers to a temperature at atmospheric pressure at or below which a given fluid mixture no longer flows but above which the same mixture will regain its fluidity.

As used herein, the term “hydraulic binder” means any mineral composition, usually of finely ground materials, which upon addition of an appropriate quantity of water forms a binding paste or slurry capable of hardening when brought into contact with water either in air or under water, thereby binding together the materials.

As used herein, the term “polymer” includes homopolymers and copolymers that are formed from two or more different monomer reactants or that comprise two distinct repeat units.

As used herein, the term “substantially water free” refers to a composition containing no added water other than water of hydration so that no hydraulic reaction occurs after 100 days storage at room temperature, or wherein the total amount of water, by weight, ranges less than 2,000 ppm, or, preferably, less than 1000 ppm.

As used herein, the term “surfactant” means a water dispersible organic molecule that contains both a hydrophilic group or phase, such as an oligoethoxylate, and a hydrophobic group or phase, such as C₈ alkyl or alkylaryl group.

As used herein, the term “total solids” refers to all materials in given composition aside from solvents, liquid carriers, unreactive volatiles, including volatile organic compounds or VOCs, and water. Ammonia does not count as a solid.

As used herein, the term “use conditions” means atmospheric or ambient pressures and temperatures at which the cement paste composition is activated and applied or poured, and may include temperatures as low as −35° C. and as high as 40° C.

As used herein, the term “weight average molecular weight” or MW refers to the weight average of the molecular weight distribution of a polymer or plasticizer material determined using gel permeation chromatography (GPC) of a polymer dispersion in water or a suitable solvent at room temperature using the appropriate conventional polyglycol, vinyl polymer, alkyl (meth)acrylate or styrene polymer standards.

As used herein, the term “weight average particle size” refers to the weight average of the particle size distribution particle size of an indicated material as determined by light scattering or another equivalent method.

As used herein, the phrase “wt. %” stands for weight percent.

In accordance with the present invention, the inventors have found that a deep eutectic solvent mixture of a polar organic carrier component, such as one or more proton donors like a glycol or glycerol, and an anhydrous cation containing component, the mixture having a freezing point of 10° C. or less, or, preferably, 0° C. or less, can be loaded with hydraulic cements, such as aluminate cements, for example, calcium aluminate cement (CAC) to solids concentrations of from 40 to 70 wt. % to give pastes that are storage stable over a period of months, for example, 100 days, while the reactivity of the cement is maintained. The cement pastes can be used as hardening additives, for example, in aqueous coatings which have a tendency to be self-levelling as an additional advantage. Because the hydraulic cement is carried in a eutectic mixture of a polar organic carrier component and an anhydrous cation containing component that is substantially free of water, and, further, contains no retarders for hydraulic cements, the compositions of the present invention become highly reactive on hydration and provide early strength and fast cure. The fluid, storage stable hydraulic cement paste compositions of the present invention can comprise many different hydraulic cements and find use, for example, as quick-set additives in various coating and construction applications such as cement pastes, cement accelerators, skim coats, mortars and road markings, as well as in water proofing membranes. The cement paste compositions of the present invention can be stored and the hydraulic cement activated by contact with water or another aqueous liquid.

In accordance with the present invention, a substantially water free cement paste composition comprises a deep eutectic solvent mixture of a polar organic carrier component, preferably, one or more polar protic organic liquids, in association with an anhydrous cation containing component, and, further comprises a hydraulic cement, wherein the deep eutectic solvent is a liquid or fluid at 10° C. or less, or, preferably, 0° C. or less, or, more preferably, −15° C. or less and at atmospheric pressure. The freezing point of the deep eutectic solvent mixture at atmospheric pressure can readily be tested by mixing to form the mixture, freezing it at atmospheric pressure and recording the freezing temperature.

Deep eutectic solvent mixtures comprise non-flammable compositions which are non-volatile in storage conditions of from −30° C. to 25° C. Such mixtures form by association of a polar organic carrier component with a cation containing component, such as through hydrogen bonding of a polar organic hydrogen bond donor and an anhydrous cation containing acceptor. The polar organic carrier component may act as a hydrogen bond, or Lewis acid that associates with the anhydrous cation containing component as a hydrogen bond or electron acceptor. The cation containing component can include one or more simple salts, such as potassium carbonate or non-toxic quaternary ammonium salts which can be either extracted from plants or biomass or readily synthesized from conventional chemical materials, such as tertiary amines and aliphatic or aromatic halides.

Suitable polar organic carrier components can comprise one or more anhydrous polar organic materials, generally in neat form, such as a hydrogen donor which can be glycerol, propoxylated glycerol, ethylene glycol, C₃ to C₁₈ alkane diols, urea, acetamide, 1-methyl urea, 1,3-dimethyl urea, thiourea, benzamide, carboxylic acids, such as oxalic, citric, succinic, malonic, adipic, or amino acids, polyols or saccharides, such as fructose or glucose, and polymerized oligomers or polymers or any two or more of these that form a deep eutectic solvent mixture that remains fluid in storage and use conditions, such as oligomers or polymers of a diol, polyol, organic acid or carbohydrate, for example, oligopolyols, polyglycerols, oligosaccharides, like a pectin, oligourethanes, or polypeptides. In the case of polar organic carrier components chosen from oligomers or polymers of a saccharide, oligomers or polymers of a polyol, oligomers or polymers of an organic acid, propoxylated glycerol, oligourethanes, polypeptides, these compounds have a formula molecular weight (formula weight) of up to 2,500, or, preferably, from 150 to 2,000, or, more preferably, a formula weight of from 150 to 1,000.

If necessary, all polar organic carrier components may be dessicated, such as by vacuum flashing, to form anhydrous or substantially water free components prior to incorporation into a deep eutectic solvent mixture.

Preferably, the polar organic carrier component of the present invention is chosen from glycerol, anhydrous ethylene glycol, urea, acetamide, 1-methyl urea, 1,3-dimethyl urea, thiourea and carbohydrates.
Preferably, in accordance with the polar organic carrier component of the present invention any (poly)organic acids are weak acids that are not highly corrosive in use.

More preferably, the polar organic carrier component in accordance with the present invention comprises 15 wt. % or less, or, preferably, 10 wt. % or less of any organic acid.

The deep eutectic solvent mixture compositions of the present invention may comprise as the polar organic carrier component polyfunctional or polymeric materials, such as polyols, polypeptides, oligoacids, polymeric polyacids, oligopolyols and polymeric polyols, preferably, those having a formula molecular weight (formula weight) of from 150 to 2,000. In general, the higher the formula weight of the polar organic carrier, the greater the proportion of the polar organic carrier component needed to form a deep eutectic solvent mixture.

Suitable anhydrous cation containing components can be chosen from non-toxic quaternary ammonium containing materials, such as one or more of choline chloride (ChCl), hydroxyethyl)trimethylammonium chloride; ammonium salts like ammonium chloride; or other organoammonium salts, such as 1-n-butyl-3-methylimidazolium salts, for example, 1-n-1-butyl-3-methylimidazoliumBF4; simple salts, including metal carbonates, like potassium carbonate, semi-metal carbonates, metal halides, semi-metal halides, metal nitrates, metal nitrites, metal sulphates,; metal phosphates; salts of cyanamide; metal citrates, metal acetates, metal phosphates and other Lewis acids; cations combined with non-volatile amines, such as hexyl amines; onium salts, such as benzyltriphenylphosphonium halides; metal cations combined with organic nitrides, such as (CF₃CO₂)₂N; metal cations combined with organic sulfonates, such as trifluoromethanesulfonate; metal cations combined with organic sulfonyl group containing compounds, such as bis(trifluoromethanesulphonyl) imide, and metal cations combined with tris(trifluoromethanesulphonyl) methide; or two or more of any of the above listed anhydrous cation containing components. If necessary, all cation containing components may be dessicated, such as by vacuum flashing, to form anhydrous components prior to incorporation into a deep eutectic solvent mixture.

The suitable anhydrous cation containing component in accordance with the cement paste composition of the present invention can comprise one or more Lewis acids, such as metal halides, like aluminum or iron halides, or (semi)metal carbonates.

Suitable anhydrous cation containing components in accordance with the present invention may also contain salt bound water in amounts that allow the compositions to remain substantially water free.

Preferably, the anhydrous cation containing component in accordance with the cement paste composition of the present invention is chosen from choline chloride or metal carbonates, such as potassium carbonate.
Suitable amounts of the polar organic carrier component in the deep eutectic solvent mixture may range from 40 to 99 mol. %, or, preferably, from 50 to 95 mol. %, or, more preferably, from 60 to 90 mol. % with the remainder comprising the anhydrous cation containing component.

Examples of a preferred deep eutectic solvent mixture include K₂CO₃; glycerol in molar ratios of from 1:1 to 1:6 or, for example, from K₂CO₃; ethylene glycol , preferably, anhydrous ethylene glycol, in weight ratios of from 1:3 to 1:8 (see F. S. Majalli et. al., Thermochimica Acta, 2014, no. 575, pages 135-143).

Deep eutectic solvent mixtures are formed by simply mixing together a polar organic carrier component and one or more cation containing component, which components are capable of forming an associative eutectic mixture. Simple mixing may comprise stirring the mixture to dissolve at a temperature of from room temperature to 150° C. or the boiling point of the polar organic carrier component, whichever is lower, or, preferably, from 40 to 100° C. for a period of from 10 min to 48 hours, or, preferably, from 60 minutes to 24 hours, and becomes easier and faster at higher temperatures with viscous components.

Suitable equipment for making a deep eutectic solvent mixture may include, for example, a mechanical stirrer, homogenizer or a dissolver, or other mechanical mixer.

In accordance with the substantially water free cement paste compositions of the present invention, any suitable hydraulic binder or cement may be used. Accordingly, the cement paste compositions of the present invention can comprise a wide variety of hydraulic setting compositions used in a wide variety of applications, including skim coats, renders or plasters, mortars, stucco, adhesives and water proofing or primers for concrete.

Suitable hydraulic binders for use in the cement paste compositions of the present invention may include Ordinary Portland cement, aluminate cements, sulpho-aluminate cement, gypsum and their mixtures.

Preferably, the hydraulic binder in accordance with the cement paste compositions of the present invention comprises a cement. More preferably, the hydraulic binder in accordance with the cement paste compositions of the present invention comprise Ordinary Portland cements, such as types CEM I, II, III, IV and V (Beuth Verlag GmbH, Berlin, DE), and/or aluminate cements, such as alkali aluminate cements, preferably alkali aluminate or sulphoaluminate cements.

The substantially water free cement paste compositions of the present invention may comprise anhydrous additives in addition to the hydraulic cement and deep eutectic solvent mixture so long as the additives do not hamper storage stability. Suitable anhydrous additives for use in the cement paste compositions may include, for example, pigments, inorganic colloidal particles or fillers (e.g. alumina or silica), reducing agents; non-aqueous polymers, such as synthetic thickeners, dispersants like polycarboxylates, and polymeric superplasticizers, like ethoxylated polycarboxylates; plasticizers, oils, defoamers, and air entraining agents. Any of the anhydrous additives useful in the cement paste compositions of the present invention can be included at any time, including at the time of use; however, such anhydrous additives must not hamper storage stability in the amounts they are used.

In accordance with the cement paste compositions of the present invention, suitable amounts of the deep eutectic solvent mixture may range from 20 to 80 wt. %, or, preferably, from 25 to 65 wt. %, based on the total weight of the composition.

In accordance with the cement paste compositions of the present invention, suitable amounts of the hydraulic cement solids may range from 20 to 73 wt. %, or, preferably, from 40 to 70 wt. %, based on the total weight of the composition. The amount of hydraulic cement should be high enough such that the composition sets within at most 48 hours and low enough so that the cement paste composition remains sufficiently fluid or liquid to enable use in the desired application.

In accordance with the cement paste compositions of the present invention, suitable amounts of the anhydrous additives, with the exception of fillers, may range from 0 to 40 wt. %, or, preferably, from 0 to 20 wt. %, based on the total weight of the cement paste composition. Substantially anhydrous fillers can be added in amounts such that the total of filler and cement solids is less than 73 wt.% of the total cement paste composition, for example, amounts of up to 60 wt.%, or, preferably, from 10 to 40 wt.%, of the total cement paste composition.

In another aspect of the present invention, methods of making the substantially water free cement paste compositions comprise forming the deep eutectic solvent mixture by mixing the polar organic carrier component and the anhydrous cation containing component, as disclosed above, in a mechanical mixer, such as in a dissolver or homogenizer, including, if desired anhydrous additives other than fillers, followed by dispersing in either order of addition, the hydraulic cement and, if desired, any anhydrous additives or fillers, in the deep eutectic solvent mixture. Such dispersing can be carried out in an extruder, or mixer, such as a cement mixer, banbury mixer, Hobart mixer, or planetary mixer, or, preferably, a cement mixer. The cement paste compositions are substantially water free and can be stored and/or shipped prior to use.

In accordance with the methods of making the substantially water free cement paste compositions of the present invention, the methods of making the cement paste compositions comprise a method of stabilizing the hydraulic cements as pastes. Accordingly, mixing a deep eutectic solvent mixture with a hydraulic cement comprises a method of stabilizing the cement. Such a method has the advantage of avoiding retarder materials because the cement paste composition will begin to set merely by bringing it in contact with water and avoids any step of removing or diluting retarders.

In yet another aspect of the present invention, methods of using the substantially water free cement paste composition of the present invention comprise bringing the cement paste composition in contact with water or aqueous liquid, preferably, by gradually adding the water, for example, in a cement mixer, to form a hydraulic setting composition, applying or pouring the resulting hydraulic setting composition, and allowing it to cure.

In coating applications, the methods of bringing the substantially water free cement paste composition into contact with water or an aqueous liquid or emulsion polymer, such as a coating composition, to form a hydraulic setting composition comprises mixing the cement paste composition with an aqueous coating composition before applying it to a substrate.

Once activated with water to form hydraulic setting compositions from the cement paste compositions of the present invention, the compositions begin to cure and release an exotherm. Accordingly, the cement paste composition once activated with water becomes a hydraulic setting composition. Water thus activates the cement paste compositions to make hydraulic setting compositions. Aside from water or aqueous coating compositions, in use additives, such as, for example, accelerators or retardants, may also be added to the cement paste compositions of the present invention to form hydraulic setting compositions. Such in use additives can be pre-mixed with water or with the cement paste compositions prior to bringing the cement paste composition into contact with water. Alternatively, all materials can be brought together simultaneously at the time of use.

Because the cement paste composition is substantially water free, only as much water as is needed to form a hydrate should be used to form a hydraulic setting composition. Accordingly, less drying is needed as part of curing and the hydraulic setting composition made from the cement paste composition of the present invention will cure faster than comparable conventional cement compositions. Preferably, water, including water as part of an aqueous coating composition, is added gradually to the cement paste compositions and comprises 40 wt. % or less, or, more preferably, 30 wt. % or less of the total final hydraulic setting compositions.

In accordance with the cement paste compositions of the present invention, the compositions may comprise from 0 to 5 wt. %, or, preferably, 0.001 wt. % or more, and 5 wt. % or less of in use additives other than water or aqueous coatings, based on the total weight of the cement paste composition.

The substantially water free cement paste compositions in accordance with the present invention find many uses and can accommodate many kinds of hydraulic cements. For example, the cement paste composition can comprise a quick set paste.

Where calcium aluminate cement is used as the hydraulic cement, the cement paste compositions in accordance with the present invention can comprise an accelerator paste.

In applications wherein an in use additive in accordance with the present invention comprises an aqueous polymer or film former as part of a coating composition, such as an acid stabilized emulsion polymer or a combination thereof with a polyamine as part of a two component coating composition, the cement paste compositions containing the coating compositions find use as exterior coatings, road markings, or other coating compositions, such as waterproofing membrane forming compositions.

### EXAMPLES

The following examples are used to illustrate the present invention without limiting it to those examples. Unless otherwise indicated, all temperatures are ambient temperatures (21-23° C.) and all pressures are 1 atmosphere. In the Examples that follow, RT means “room temperature” which is equivalent to ambient temperature.

Materials used in the Examples, below, include the following materials: Calcium aluminate cement 1 or CAC 1: Calcium aluminate cement (Calcium aluminate content: >90% (92 to 98%)), HiPercem™ cement (Calucem, Mannheim, Del.);

Calcium aluminate cement 2 or CAC 2: Ternal™ white cement (calcium aluminate content: 97 to 99.7%) (Imerys (Kerneos), Paris, FR);

Calcium aluminate cement 3: Ternal™ white cement which is stabilized with aqueous phosphoric acid, pH ˜7.

Polyol 1: Glycerine propoxylated polyether having a FW 300 g/mol and having an average of three (3) OH groups and a FW of about 300.

### Example 1: Cement Paste Preparation and Storage

Deep eutectic solvent mixture preparation: First, part B, a deep eutectic solvent mixture was prepared by mixing K₂CO₃ and glycerol in a molar ratio of 1:4.8 in a mechanical mixer equipped with a polytetrafluoroethylene coated magnetic stirrer at 90° C. (in a water bath at that temperature) to form a stable carrier mixture until dissolved or 24 h, whichever is shorter.

Cement paste preparation: Calcium aluminate cement 1, Part A, with the deep eutectic solvent mixture, part B, in a weight ratio of 57.5:42.5 was mixed in a mechanical mixer at from 60 to 90° C. by adding Part A in ten roughly equal portions, wherein each portion was mixed for one (1) minute and then the resulting product was mixed for 5 more minutes. The paste was stored at room temperature (RT or 22° C.) over 100 days without hardening (FIG. 1). Stability results from visual inspection are as shown in Table 1, below.

### Example 1A: Comparative Paste Preparation

As a comparative example, the Example 1 was repeated with glycerol only as Part B instead of a deep eutectic solvent mixture. It was not possible to form a paste. The glycerol and cement phase separated within <5 days after mixing and became compacted at the bottom of the vessel (FIG. 1). Stability results were as shown in Table 1, below.

### Example 1 B: Comparative Paste Preparation in Water

As a comparative example, the Example 1 was repeated with water only as Part B instead of a deep eutectic solvent mixture. It was not possible to keep the mixture from setting after a short period.

TABLE 1
Cement paste composition stability

| | Part A: | | | | | |
|---|---|---|---|---|---|---|
| | Calcium | Amount | Part B: | Amount | | |
| | aluminate | of Part | Deep eutectic | of Part | | |
| Name | cement No. | A (wt. %) | solvent mixture | B (wt. %) | Paste | Stability |
| Ex. 1 | 1 | 57.5 | K₂CO₃:Glycerol | 42.5 | yes | Homogeneous |
| | | | (1:4.8 mol/mol) | | | and Stable |
| Comp. | 1 | 57.5 | Glycerol | 42.5 | no | Sedimentation, |
| 1A* | | | | | | hardening |
| Comp. | 1 | 57.5 | Water | 42.5 | slurry | Hydraulic |
| 1B* | | | | | | hardening |

*Denotes comparative example.

As shown in Table 1, above, after 100 days storage, calcium aluminate cement 1 (CAC 1) mixed with solely glycerol in Comparative Ex. 1 A formed a sediment and hardened, i.e. it was unusable. In contrast, in inventive Example 1, CAC 1 stabilized in a deep eutectic solvent mixture exhibited a stable paste (Ex. 1). Likewise, in Comparative example 1B wherein CAC 1 was mixed with water, the result was not stable over time; rather the cement set and hardened and could not be dispersed.

### Example 2: Cement and Deep Eutectic Solvent Mixture Variations and Setting Time

The cement pastes indicated in Table 2, below, were prepared using the indicated deep eutectic solvent mixtures and the indicated calcium aluminate cements, CAC 1 or CAC 2. To demonstrate the versatility of the present invention, the indicated deep eutectic solvent mixtures in Table 2, below were prepared by mixing potassium carbonate with each of glycerol, ethylene glycol or Polyol 1, as indicated in the table, in a mechanical mixer equipped with a polytetrafluoroethylene coated magnetic stirrer at 750 rpm at the following temperatures: For Examples 2A and 2B, from 60 to 90° C., and, for the remaining Examples 2C, 2D, 2E, 2F and 2G at 23° C. to form a stable carrier mixture. Each cement paste was formed at from RT by adding cement in ten equal portions to the indicated deep eutectic solvent mixture in a mechanical mixer and mixing each for about 1 minute; thereafter, mixing was continued for 5 minutes. All pastes were then activated with water and mixed until homogeneous for as long as 10 minutes to form hydraulic setting compositions and, subsequently filler was added (silica flour, Silverbond™ M500 silica, Sibelco, Antwerp, Belgium) and mixed for 2 to 4 minutes to form hydraulic setting compositions. During mixing with water, pH was adjusted to 12.7, if required with NaOH 50% w/w. The setting time (Vicat Hardening time) was tracked with a

Vicatronic E044N Vicat tester (Vicatronic, Ile-De-France, FR), wherein the tester dips a 300 g needle from a normal or 90° angle into the curing hydraulic setting composition formulation and measures the distance the needle penetrates at a 30 min time interval. The compositions are considered cured when the needle cannot penetrate the composition.

TABLE 2
Setting Performance

| | Part B: | Calcium | | | | | | |
|---|---|---|---|---|---|---|---|---|
| | Deep eutectic | aluminate | Paste | | Filler/ | Water/ | Vicat | |
| | solvent mixture | cement | CAC | Part B | Paste | CAC | hardening | |
| Example | (mol/mol) | (CAC) No. | (wt. %) | (wt. %) | (w/w) | (w/w) | time (h) | pH |
| 2A | K₂CO₃:Glycerol | 2 | 71 | 29 | 0.8 | 0.5 | 3 | 12.7 |
| | (1:4.8) | | | | | | | |
| 2B | K₂CO₃:Glycerol | 1 | 69 | 31 | 0.8 | 0.5 | 3 | 12.7 |
| | (1:4.8) | | | | | | | |
| 2C | K₂CO₃:Ethylene | 1 | 73 | 27 | 0.4 | 0.6 | 5 | 12.7 |
| | glycol (1:4.8) | | | | | | | |
| 2D | K₂CO₃:Ethylene | 2 | 71 | 29 | 0.2 | 0.5 | 7 | 12.7 |
| | glycol (1:4.8) | | | | | | | |
| 2E | K₂CO₃:Ethylene | 1 | 73 | 27 | 0.4 | 0.6 | 3 | 12.7 |
| | glycol (1:4.8), | | | | | | | |
| | Lithium sulphate | | | | | | | |
| | monohydrate 1 wt. % | | | | | | | |
| | vs. CAC | | | | | | | |
| 2F | K₂CO₃:Polyol 1 | 2 | 73 | 27 | 0.7 | 0.6 | 12 | 12.7 |
| | (1:16) | | | | | | | |
| 2G | K₂CO₃:Polyol 1 | 1 | 73 | 27 | 0.7 | 0.6 | 12 | 12.7 |
| | (1:16) | | | | | | | |

All pastes in Table 2, above, were activated and react when mixed with water, showing that storage does not impede the hydraulic reaction of the cement. Comparing the Vicat hardening time of Example 2D with that of Example 2E shows that salt accelerators (lithium sulphate monohydrate) as in use additives can be used to further shorten the hardening time.

### Example 3. Storage Stability of Some Cement Pastes

Substantially water free cement paste compositions were prepared as described in Example 2, above except using the compositions indicated in Table 3, below. Each composition was formed at from RT by adding the indicated cement in 5 equal portions to the indicated deep eutectic solvent mixture (50 g) in a mechanical mixer and mixing each for about 1 minute; thereafter, mixing was continued for 3 minutes. The pastes were transferred to plastic cups that were enclosed with a plastic lid, and sealed with semi-transparent laboratory sealing film (Parafilm M™, Pecheney Plastics Packaging, Chicago, Ill.) and stored under controlled conditions (23° C. and 50% rel. humidity). At the end of the indicated storage time, syneresis or separation of liquid from solid was visually evaluated and hardening was determined by evaluating whether the material is deformable by hand, by squeezing the plastic cup and check if paste deform pressing finger on the sample. Acceptable substantially water free cement paste compositions did not exhibit any syneresis or hardening.

TABLE 3
Storage stability

| | Part B: | Calcium | | | | | |
|---|---|---|---|---|---|---|---|
| | Deep eutectic | aluminate | Paste | | Storage | | |
| | solvent mixture | cement | CAC | Part B | time | Syneresis | Hardening |
| Example | (mol/mol) | (CAC) No. | (wt. %) | (wt. %) | (days) | (w/w) | (w/w) |
| 3A | K₂CO₃:Ethylene | 2 | 71 | 29 | 7 | No | No |
| | Glycol as 1:4.8 | | | | | | |
| 3B | K₂CO₃:Ethylene | 1 | 73 | 29 | 7 | No | Yes |
| | Glycol as 1:4.8 | | | | | | |
| 3C | K₂CO₃:Ethylene | 2 | 57.5 | 42.5 | 6 | No | No |
| | Glycol as 1:4.8 | | | | | | |
| 3E | K₂CO₃:Polyol 1 | 2 | 71 | 29 | 26 | No | No |
| | (1:16) | | | | | | |

As shown in Table 3, above, all of the inventive compositions were shelf stable in relation to syneresis and hardening except for Example 3B which hardened fully. Example 3B appears to have hardened, at least in part, because of the high 73 wt. %

weight ratio of CAC 2 and the very high calcium aluminate content of 97+ wt. % of CAC 2. Example 3A, in comparison, comprises an amount of calcium aluminate cement in the preferred proportion and uses a calcium aluminate cement having a calcium aluminate content averaging about 95 wt. % of the cement.

We claim:

1. A substantially water free cement paste composition comprising a deep eutectic solvent mixture of a polar organic carrier component, in association with an anhydrous cation containing component, and, further, a hydraulic cement, wherein the deep eutectic solvent is a liquid or fluid at 10° C. or less.

2. The substantially water free cement paste composition as claimed in claim 1, wherein the polar organic carrier component is chosen from glycerol, ethylene glycol, C₃ to C₁₈ alkane diols, urea, acetamide, 1-methyl urea, 1,3-dimethyl urea, thiourea, benzamide, carboxylic acids, polyols or carbohydrates, oligomers or polymers of a diol, oligomers or polymers of a polyol, oligomers or polymers of an organic acid, oligomers or polymers of a carbohydrate, oligourethanes, polypeptides, or two or more of these.

3. The substantially water free cement paste composition as claimed in claim 1, wherein the polar organic carrier component is chosen from glycerol, polyalkoxylated glycerol, ethylene glycol, urea, acetamide, 1-methyl urea, 1,3 -dimethyl urea, thiourea, carbohydrates, or two or more of these.

4. The substantially water free cement paste composition as claimed in claim 1, wherein the amount of the polar organic carrier component in the deep eutectic solvent mixture ranges from 40 to 99 mol. %, with the remainder comprising the anhydrous cation containing component.

5. The substantially water free cement paste composition as claimed in claim 1, wherein the anhydrous cation containing component is chosen from non-toxic quaternary ammonium containing materials, ammonium salts, organoammonium salts, simple salts of metals, salts of cyanamide, metal cations combined with non-volatile amines, onium salts; metal cations combined with organic nitrides, metal cations combined with organic sulfonates, metal cations combined with organic sulphonyl group containing compounds, or two or more of these.

6. The substantially water free cement paste composition as claimed in claim 5, wherein the anhydrous cation containing component is chosen from choline chloride (ChCl), (hydroxyethyl) trimethylammonium chloride, ammonium chloride, 1 -n-butyl-3-methylimidazolium salts, metal carbonates, semi-metal carbonates, metal halides, semi-metal halides, metal nitrates, metal nitrites, metal sulphates, metal phosphates, salts of cyanamide, metal citrates, metal acetates, metal cations combined with non-volatile amines, benzyltriphenylphosphonium halides, metal cations combined with (CF₃CO₂)₂N, metal cations combined with trifluoromethanesulfonate, metal cations combined with bis(trifluoromethanesulphonyl) imide, metal cations combined with tris(trifluoromethanesulphonyl) methide, or two or more of any of these.

7. The substantially water free cement paste composition as claimed in claim 1, wherein the deep eutectic solvent mixture comprises K₂CO₃ and glycerol in molar ratios of from 1:1 to 1:6, K₂CO₃ and ethylene glycol in molar ratios of from 1:3 to 1:8 or K₂CO₃ and propoxylated glycerol in molar ratios of from 1:16 to 1:30.

8. The substantially water free cement paste composition as claimed in claim 1, wherein the hydraulic cement is chosen from Ordinary Portland cement, aluminate cement, sulpho-aluminate cement, gypsum and their mixtures.

9. The substantially water free cement paste composition as claimed in claim 1, wherein the amounts of the deep eutectic solvent mixture range from 20 to 80 wt. %, based on the total weight of the composition.

10. The substantially water free cement paste composition as claimed in claim 1, wherein the amounts of the hydraulic cement solids range from 20 to 73 wt. %, based on the total weight of the composition.
